(19) United States
(12) Patent Application Publication
(10) Pub. No.: US 2023/0411709 A1
(43) Pub. Date: Dec. 21, 2023

(54) SYSTEMS FOR PROVIDING A COMMON BATTERY PILOTING CHANNEL AND VEHICULAR AMPLIFIER ADAPTER RETENTION

(71) Applicant: Thales Defense & Security, Inc., Clarksburg, MD (US)

(72) Inventors: Jeffrey DICKENS, Baltimore, MD (US); Douglas BELL, North Potomac, MD (US); Sarah STUCHLIK, Rockville, MD (US); Evan WINTER, Alexandria, VA (US); Merdod BADIE, North Potomac, MD (US)

(21) Appl. No.: 18/336,648

(22) Filed: Jun. 16, 2023

Related U.S. Application Data
(60) Provisional application No. 63/353,235, filed on Jun. 17, 2022.

(51) Int. Cl. H01M 10/42; H01R 13/213

(52) U.S. Cl. CPC H01M 10/4257; H01R 13/213; H01M 2220/30; H01R 2201/24

(57) ABSTRACT

A common battery for providing power to a first of a plurality of radios. The plurality of radios includes at least a first radio and a second radio. The common battery has a size of the smallest of at least two batteries. The common battery comprises a raised concentric wall edge for enabling the common battery to lock in place when used in place of a larger of the first battery and the second battery, such as within a Vehicular Adaptor Amplifier. The raised concentric wall edge has a height of a difference between a height of the first battery and a height of the second battery. In one variation, the common battery comprises a circular piloting interface that uses an outside radius of a respective bayonet connector on the first and second radios to align the common battery to the respective radio.

### CROSS REFERENCE TO RELATED APPLICATIONS

The present application claims priority to U.S. Provisional Application No. 63/353,235, filed on Jun. 17, 2022, the entire content of which is incorporated herein by reference.

### BACKGROUND

### Field

Aspects of the present disclosure relate generally to batteries used in handheld radios, such as the Thales AN/PRC-148D and the L3 Harris AN/PRC-163 radios. In particular, the present disclosure is related to improvements in interfaces of batteries used in handheld radios, such as the Thales AN/PRC-148D and the L3 Harris AN/PRC-163 radios and associated Vehicular Amplifier Adapters (VAAs).

### Background

Handheld radios commonly used in missions include the Thales AN/PRC-148D radio (interchangeably referred to herein as the “AN/PRC-148D” or “Thales”) and the L3 Harris AN/PRC-163 radio (interchangeably referred to herein as “AN/PRC-163” or “L3 Harris”). Currently, these two types of radios use different batteries. There are two design differences that prevent usage of a common battery for both types of radios. First, the two types of radios have different radio to battery interfaces. Second, the sizes of batteries needed for the two types of radios are different, thereby causing incompatibilities in VAAs.

There remains an unmet need for a battery that can be used in both the AN/PRC-163 and the AN/PRC-148 radios without alignment issues and other incompatibilities.

### SUMMARY

In light of the above described problems and unmet needs, as well as others, aspects of the design, development, and testing of a system for providing a common battery piloting channel and a VAA retention are described herein. Among other applications, these aspects can be used for, e.g., handheld radios, such as the AN/PRC-148D, the AN/PRC-163 radio, and the like.

In at least an aspect of the disclosure, a system for providing a common battery piloting channel and a VAA retention are provided. The system provides a common battery for use in a handheld radio that includes components for establishing secure communication, including full motion video and audio, and displays.

In one aspect, a system is disclosed for providing power to one of a plurality of radios.

In one aspect, the plurality of radios includes at least a first radio and a second radio.

In one aspect, the common battery has a size of a smaller of: a size of a first battery of the first radio and a size of a second battery of the second radio.

In one aspect, the common battery comprises a raised concentric wall edge for enabling the common battery to lock in place when used in place of a larger of the first battery and the second battery within a Vehicular Adaptor Amplifier, the raised concentric wall edge having a height of a difference between a height of the first battery and a height of the second battery.

In one aspect, the common battery comprises a circular piloting interface that uses an outside radius of a respective bayonet connector on the first radio and the second radio to align the respective radio to the common battery.

In one aspect, the first radio comprises AN/PRC-148D radio and the second radio comprises an AN/PRC-163 radio.

In one aspect, a housing of the common battery comprises the raised concentric wall edge configured to lock in place the common battery within vehicular amplifier adaptors for an AN/PRC-163 radio and an AN/PRC-148 radio.

In one aspect, the system can include a handheld radio that further comprises a display and/or a video capability.

In one aspect, the system of the present disclosure provides power to a first radio of a plurality of radios, the plurality of radios including at least a first radio and a second radio, the system including at least: a common battery having a size of a smaller of a size of a first battery of the first radio and a size of a second battery of the second radio, the common battery comprising: a raised concentric wall edge for enabling the common battery to lock in place when used in place of a larger of the first battery and the second battery within a Vehicular Adaptor Amplifier, the raised concentric wall edge having a height of a difference between a height of the first battery and a height of the second battery; and a circular piloting interface that uses an outside radius of a respective bayonet connector on the first radio and the second radio to align the respective radio to the common battery.

In one aspect, the system further comprises a display component.

In one aspect, the first radio includes the display component.

In one aspect, the display component is mountable on a wearable object.

In one aspect, the system further comprises a video capture and transmission component.

In one aspect, the system further comprises a positioning system.

In one aspect, the system further comprises an antenna.

In one aspect, the system further comprises a frequency management and/or selection module.

In one aspect, the system further comprises a motion sensor.

Additional advantages and novel features of these aspects will be set forth in part in the description that follows, and in part will become more apparent to those skilled in the art upon examination of the following or upon learning by practice of the disclosure.

### BRIEF DESCRIPTION OF THE DRAWINGS

Various example aspects of the systems will be described in detail, with reference to the following figures, wherein:

FIG. 1 illustrated a representative diagram of an example system for communicating with handheld radios that use the common battery in according to aspects of the present disclosure;

FIG. 2 is an example battery in accordance with aspects of the present disclosure;

FIG. 3 illustrates a comparison of the traditional AN/PRC-163 battery and the AN/PRC-148D battery along with the common battery of the present disclosure;

FIG. 4 illustrates top view, side view, and section view of the common battery of the present disclosure;

FIG. 5 presents an example system diagram of various hardware components and other features, for use in accordance with aspects of the present disclosure;

FIG. 6 is a block diagram illustrating various example system components for use in accordance with aspects of the present disclosure; and

FIG. 7 illustrates an example comparison of the common battery in accordance with aspects of the present disclosure, the AN/PRC-163 battery, and the AN/PRC-148 battery, displaying an isometric view of the circular piloting alignment feature on the common battery as well as the raised plastic wall on the AN/PRC-163 battery.

### DETAILED DESCRIPTION

The detailed description set forth below in connection with the appended drawings is intended as a description of various configurations and is not intended to represent the only configurations in which the concepts described herein can be practiced. The detailed description includes specific details for the purpose of providing a thorough understanding of various concepts. However, it will be apparent to those skilled in the art that these concepts can be practiced without these specific details. In some instances, well known structures and components are shown in block diagram form in order to avoid obscuring such concepts.

Several aspects of handheld radios will now be presented with reference to various apparatuses. These apparatuses will be described in the following detailed description and illustrated in the accompanying drawings by various blocks, components, circuits, steps, processes, algorithms, etc. (collectively referred to as “elements”). These elements can be implemented using electronic hardware, computer software, or any combination thereof. Whether such elements are implemented as hardware or software depends upon the particular application and design constraints imposed on the overall system.

By way of example, an element, or any portion of an element, or any combination of elements can be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system can execute software. Software shall be construed broadly to include instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described can be implemented in hardware, software, firmware, or any combination thereof. If implemented in software, the functions can be stored on or encoded as one or more instructions or code on a computer-readable medium. Computer-readable media include computer storage media. Storage media can be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above are also included within the scope of computer-readable media.

Accordingly, in one or more aspects, the functions described below can be implemented for radios that have batteries compatible with AN/PRC-148D and AN/PRC-163. As described above, the AN/PRC-148D and AN/PRC-163 radios use different batteries because they have different radio to battery interfaces and have design differences in regard to sizes of batteries needed for compatibilities in VAAs.

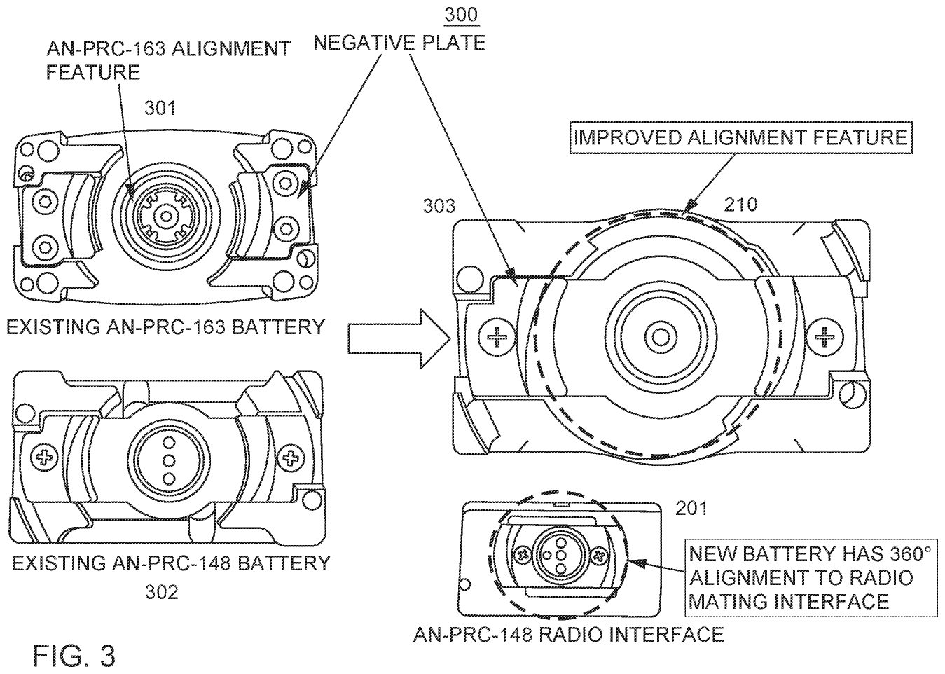

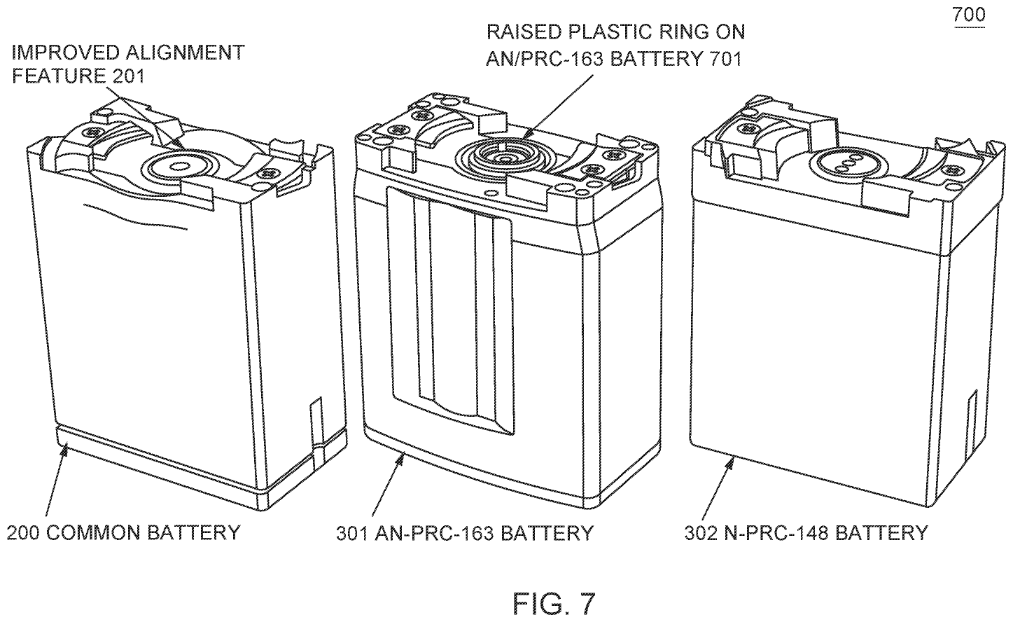

In regard to the interface issues, the radio to battery interface of the AN/PRC-163 (L3 Harris) radio has 4 long pogo pins on the bottom of the radio for power and Data Quality (DQ) communications to the battery. These long pins can be damaged if they are side loaded. The damage occurs, for example, if the battery is misaligned during installation. In order to prevent damage to the long pins, the current production L3 Harris battery has a tall, molded plastic ring around the battery contacts which engages the bottom on the radio to prevent misalignment. However, the tall, molded plastic ring can cause interference if the battery is to be used for the AN/PRC-148 family of radios. The tall, molded plastic ring on L3 Harris batteries is further describes in conjunction with the descriptions of FIG. 3 and FIG. 7.

In regard to the battery size issues, the L3 Harris battery is roughly 0.10 inches longer than the Thales battery. Thus, using the longer L3 Harris battery for both radios would cause the radio/battery assembly to be misaligned to the side connector mate of the Thales VAA, and using the smaller Thales battery for both radios would fall short of the bottom contact power, ground and the System Management Bus (SMBUS) communication pins in the L3 Harris VAA. Thus, using either of the existing batteries for both types of radios creates a VAA fit problem, among other issues.

Using a longer battery as the common battery would cause the radio/battery assembly to be misaligned to the side connector mate of the Thales VAA, while using a shorter battery as the common battery would fall short of the bottom contact power, ground, and SMBUS communication pins in the L3 Harris VAA. The present disclosure describes a solution that provides a common battery with a novel alignment mechanism that enables the battery to be used for both the AN/PRC-163 radio and the AN/PRC-148 radio. The common battery of the present disclosure maintains the overall size of the smaller battery while adding a feature to lock the battery in place at the same height as the larger battery. For the example above, the common battery of the present disclosure maintains the overall size of the battery of the AN/PRC-148 handheld radio while adding a feature to lock the battery in place at the same height as the current battery of the AN/PRC-163 handheld radio.

In one aspect, the common battery of the present disclosure includes a piloting channel on top of the battery. The piloting channel of the common battery can use the outside radius of the bayonet connector on the AN/PRC-163 and AN/PRC-148 radios to align the battery to the respective radio.

For the AN/PRC-163, the usage of the piloting channel can enable full capture of the bayonet limiting side to side movement—thereby protecting the pins of the AN/PRC-163.

For the AN/PRC-148, the usage of the piloting channel can significantly improve the battery alignment to the radios. With the existing Thales battery used for the AN/PRC-148 radios, there is a potential that the battery can be installed incorrectly such that one battery negative plate is not mated with the radio bayonet connector. Due to the design of the Thales pogo pins, there is no risk of damage if misalignment occurs. However, misalignment can stop the battery from powering the radio and can cause the user to perform multiple installations. With a piloting channel, this problem can be substantially reduced or mitigated.

The piloting channel of the common battery can also include a concentric wall edge on the outside of the battery that matches the 0.1 inch extra height of the L3 Harris battery and locally increase the width at the top of the battery slightly beyond that of the Thales battery. This creates a surface at the correct location for the L3 Harris VAA to latch onto. This added size can still be smaller than the outside dimensions of the AN/PRC-148D radio, thereby preventing or reducing any fit issues with the Thales VAA or any other accessory.

The innovative raised concentric wall edge design can solve a height difference issue between the current production AN/PRC-148D battery and the AN/PRC-163 battery, allowing a common battery to be used with either of the radios' VAAs. It is noted that the voltage and current characteristics of these batteries are compatible. This unique feature allows the battery to be locked in place by the existing latch in the L3 Harris VAA while retaining the 0.1 inch shorter length necessary for alignment in the Thales VAA. Moreover, this feature can enable the battery to be used in both types of radios without requiring an adapter for use with either VAA. In addition, the fit can be such that any negative effect for any approved battery chargers is mitigated.

As described above, the common battery of the present disclosure includes a circular piloting interface and a raised concentric wall edge. These two features of the common battery allow interoperability such that the battery can be used for either the Thales or the L3 Harris radios and the respective VAAs without the need for adapters.

In one aspect, the piloting interface of the common battery includes a design for proper alignment with the negative plate on the bottom of either of the AN/PRC-148D and the AN/PRC-163 batteries. That is, the circular piloting interface and a raised concentric wall edge allow the common battery to properly align with the negative plate on the bottom of either of the AN/PRC-148D and the AN/PRC-163 batteries. Moreover, the design avoids damage to the long pogo pins of the AN/PRC-163 from accidental side loading.

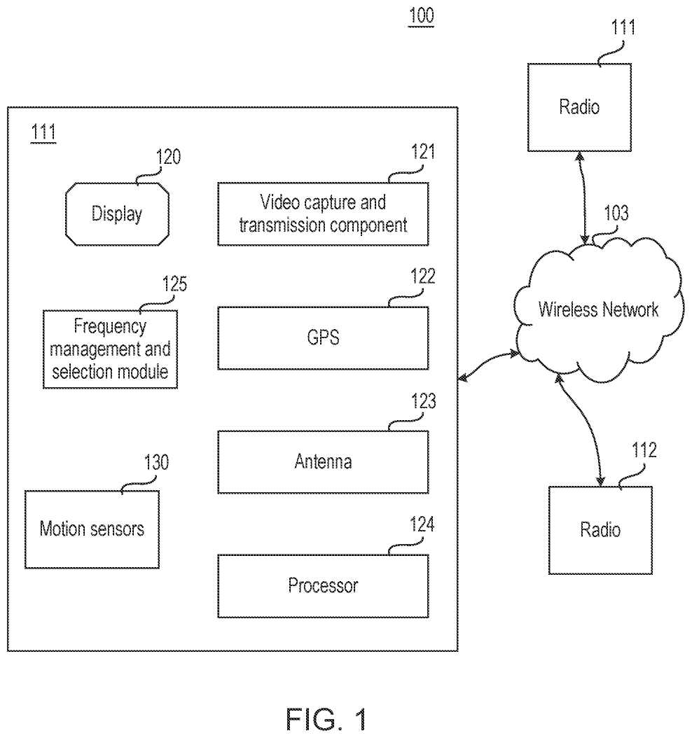

Referring to FIG. 1, therein illustrated is a representative diagram of an example system 100 for communicating with radios, e.g., handheld radios, that use the common battery in according to an aspect of the present disclosure. The system 100 can comprise any number of radios, such as handheld radios 111, 112, communicating over a wireless network 103.

A handheld radio 111, 112 can comprise any number of other components, such as a display 120, a video capture and transmission component 121, a positioning system (e.g., GPS) 122, antenna 123, at least one processor 124, frequency management and selection module 125, and motion sensors 130, among other elements.

In one aspect, the radios 111, 112 of the present disclosure can be handheld, mounted on a wearable object, mounted on another object (e.g., a vehicle), etc.

In one aspect, the handheld radios 111, 112 of system 100 can comprise at least any combination of the Thales AN/PRC-148D radio and the L3 Harris AN/PRC-163 radio.

In one aspect, the handheld radios 111, 112 of system 100 can operate using channels in different frequency ranges. For example, a channel can be in a Satellite Communication (SATCOM), Very High Frequency (VHF), Ultra High Frequency (UHF), or Mobile Ad-Hoc Networking (MANET) frequency range.

For instance, if the handheld radio 111, 112 is the L3 Harris AN/PRC-163, the radio can operate in the following frequency ranges:
VHF low frequency range of 30-88 MHz,
VHF high frequency range of 118-174 MHz,
UHF frequency range of 225-512 MHz,
SATCOM frequency range of 300-320 MHz UL/360-380 MHz DL,
UHF SATCOM frequency range of 291-318.3 MHz UL/243-270 MHz DL,
Signals-Based Threat Warning/Situational Awareness (SBTW/SA) frequency range of 30-2600 MHz,
UHF frequency range of 225-450 MHz, and
L-band (1-2 GHz) and S-band (2-4 GHz) frequency ranges.

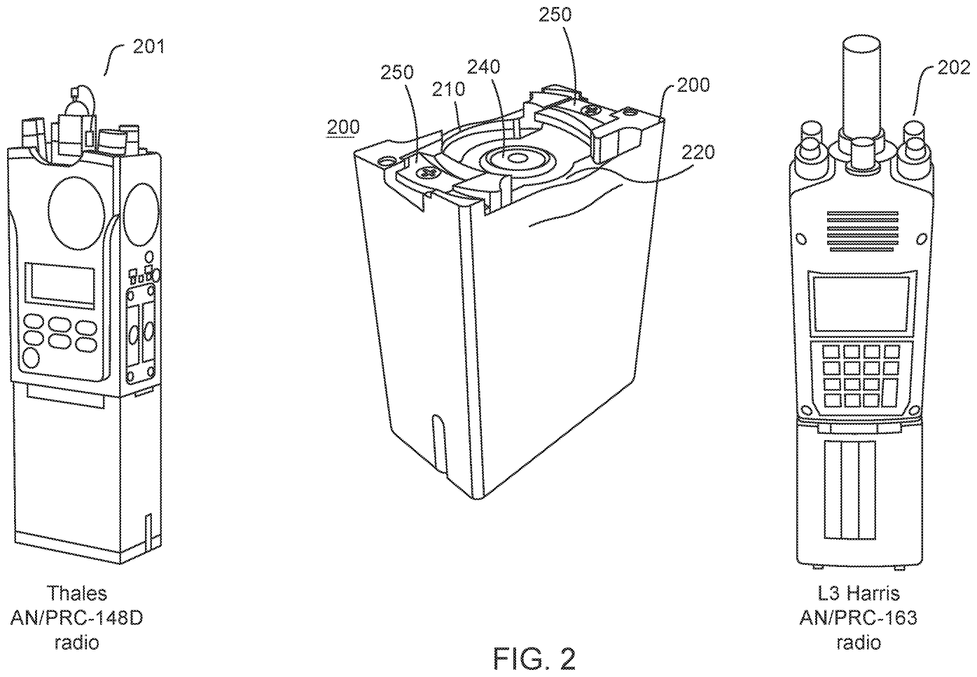

FIG. 2 illustrates an example of a common battery 200 in accordance with aspects of the present disclosure. In one aspect, the common battery 200 can be usable at least with an AN/PRC-148D radio 201 and an AN/PRC-163 radio 202. In one aspect, the common battery 200 has a size of the battery of the AN/PRC-148 handheld radio, which is the smaller of the battery of the AN/PRC-163 radio and the battery of the AN/PRC-148D radio. The varies features of the common battery 200 are described below in conjunction with FIG. 3.

In one aspect, the common battery 200 comprises a raised concentric wall edge 210 for enabling the common battery to lock in place within a vehicular amplifier adaptor when used in place of a larger of the first battery of the first radio and the second battery of the second radio (i.e., in place of the larger of the AN/PRC-163 battery and the AN/PRC-148D batteries). The raised concentric wall edge 210 has a height of the difference between the two batteries. For example, the difference between the heights of the AN/PRC-163 battery and the AN/PRC-148D battery is 0.1 inches. Thus, the raised concentric wall edge 210 has a height of 0.1 inches when the two batteries being replaced by the common battery 200 are the batteries of the AN/PRC-163 and AN/PRC-148D radios. In one aspect, the common battery 200 can comprise a circular piloting interface 220 that uses an outside radius of a respective bayonet connector 240 on the AN/PRC-163 and AN/PRC-148 radios to align the common battery 200 to the respective radio.

FIG. 3 illustrates an example comparison of the existing AN/PRC-163 battery 301 and the existing AN/PRC-148 battery 302 along with the common battery 200, in accordance with aspects of the present disclosure. FIG. 3 highlights the circular piloting alignment feature on the common battery, the alignment feature on the AN/PRC-163 battery, and the bayonet mating interface on the bottom of an AN/PRC-148 radio, as described in more detail below. All three battery designs (i.e., for the common battery 200, the existing AN/PRC-163 battery 301, and the existing AN/PRC-148 battery 302) allow attaching the battery to the radio through a twisting motion that captures the plate on the bottom of the radio under the two negative plates on the battery. With both the AN/PRC-163 battery 301 and AN/PRC-148 battery 302 the primary alignment feature is the partial arcs in the battery housing right at the entrance of the negative plates 250 intended to guide the radio plate, as shown in 303. This feature however is insufficient to ensure proper alignment and mating causing the user to have to reinstall if the battery is improperly or partially installed. The AN/PRC-163 battery 301 also has a secondary alignment feature of a raised ring around the center contacts. This feature prevents damage on the long pogo pins on the AN/PRC-163 radio during installation; however, this feature prevents installation of the battery on an AN/PRC-148 radio. The improved alignment feature 210 of the common battery 200 provides 360 degree alignment to the radio plate, as shown in 303. This feature ensures the battery can be installed and properly aligned on either radio. This feature limits lateral movement of the radio during installation which limits the risk of damaging the radio pogo pins while maintaining interoperability with the exiting radios, radio accessories, and vehicle amplifiers. FIG. 7 illustrates isometric views of the L3 Harris, Thales, and common batteries.

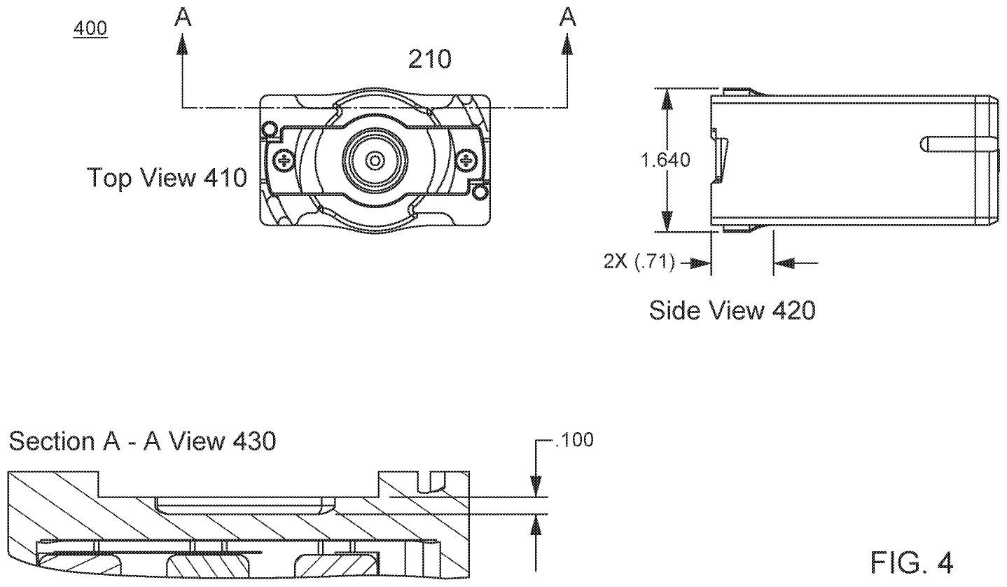

FIG. 4 illustrates a top view 410, side view 420, and section view 430 of the common battery 200, in accordance with one aspect of the present disclosure. It should be noted that the section view 430 is shown on the top view 410 (marked as Section A-A).

As described above, the common battery of the present disclosure can be used instead of the traditional AN/PRC-163 batteries 301 and AN/PRC-148D batteries 302. However, there can be other handheld radios on which the common battery can be used.

In one aspect, the present disclosure is directed to a common battery for providing power to a radio of a plurality of radios. In one aspect, the plurality of radios includes at least a first radio and a second radio. In one aspect, the common battery has a size of the smaller of the sizes of the batteries of the first radio and the second radio. In one aspect, the common battery can comprise a raised concentric wall edge for enabling the common battery to lock in place when used in place of a larger of the first battery and the second battery, the raised concentric wall edge having a height of a difference between a height of the first battery and a height of the second battery. In one aspect, the common battery further comprises a circular piloting interface that uses an outside radius of a respective bayonet connector 240 on the first radio and the second radio to align the respective radio to the common battery. The section view 430 of the common battery 200 includes a design for receiving the two types of batteries described above. Since the Harris battery is roughly 0.10 inches longer than the Thales battery, the design includes the 0.10 inches as shown in 431.

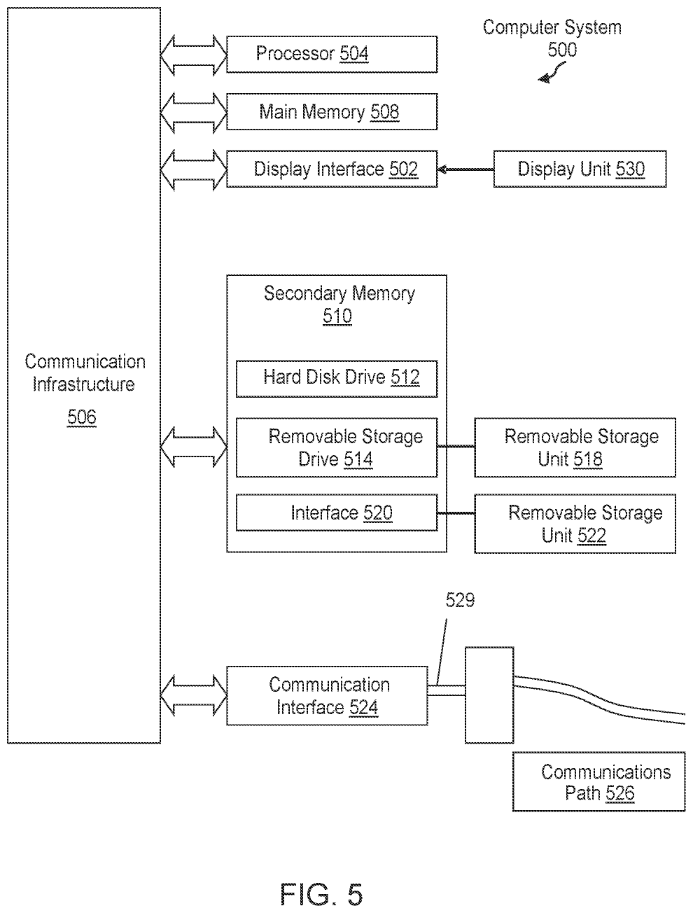

FIG. 5 presents an example system diagram of various hardware components and other features, for use in accordance with aspects presented herein. The aspects can be implemented using hardware, software, or a combination thereof and can be implemented in one or more computer systems or other processing systems. In one example, the aspects can include one or more computer systems capable of carrying out the functionality described herein, e.g., in connection with one or more of the motion sensors (e.g., IMUs), displays, INS, and/or related processing within other components in the system for communicating with handheld radios, as shown in FIGS. 1-4. An example of such a computer system 500 is shown in FIG. 5.

Computer system 500 includes one or more processors, such as processor 504. In at least one aspect, the processor 504 can correspond to the IMUs described in connection with system 600. The processor 504 is connected to a communication infrastructure 506 (e.g., a communications bus, cross-over bar, or network). Various software aspects are described in terms of this example computer system. After reading this description, it will become apparent to a person skilled in the relevant art(s) how to implement the aspects presented herein using other computer systems and/or architectures.

Computer system 500 can include a display interface 502 that forwards graphics, text, and other data from the communication infrastructure 506 (or from a frame buffer not shown) for display on a display unit 530. Computer system 500 also includes a main memory 508, preferably random access memory (RAM), and can also include a secondary memory 510. The secondary memory 510 can include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well-known manner. Removable storage unit 518, represents a floppy disk, magnetic tape, optical disk, etc., which is read by and written to removable storage drive 514. As will be appreciated, the removable storage unit 518 includes a computer usable storage medium having stored therein computer software and/or data.

In alternative aspects, secondary memory 510 can include other similar devices for allowing computer programs or other instructions to be loaded into computer system 500. Such devices can include, for example, a removable storage unit 522 and an interface 520. Examples of such can include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 can also include a communications interface 524. Communications interface 524 allows software and data to be transferred between computer system 500 and external devices. Examples of communications interface 524 can include a modem, a network interface (such as an Ethernet card), a communications port, a Personal Computer Memory Card International Association (PCMCIA) slot and card, etc. Software and data transferred via communications interface 924 are in the form of signals 528, which can be electronic, electromagnetic, optical or other signals capable of being received by communications interface 524. These signals 529 are provided to communications interface 524 via a communications path (e.g., channel) 526. This path 526 carries signals 529 and can be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 514, a hard disk installed in hard disk drive 512, and signals 529. These computer program products provide software to the computer system 500. Aspects presented herein can include such computer program products.

Computer programs (also referred to as computer control logic) are stored in main memory 508 and/or secondary memory 510. Computer programs can also be received via communications interface 524. Such computer programs, when executed, enable the computer system 500 to perform the features presented herein, as discussed herein. In particular, the computer programs, when executed, enable the processor 504 to perform the features presented herein. Accordingly, such computer programs represent controllers of the computer system 500.

In aspects implemented using software, the software can be stored in a computer program product and loaded into computer system 500 using removable storage drive 514, hard drive 512, or interface 520 to removable storage unit 522. The control logic (software), when executed by the processor 504, causes the processor 504 to perform the functions as described herein. In another example, aspects can be implemented primarily in hardware using, for example, hardware components, such as application specific integrated circuits (ASICs). Implementation of the hardware state machine so as to perform the functions described herein will be apparent to persons skilled in the relevant art(s).

In yet another example, aspects presented herein can be implemented using a combination of both hardware and software.

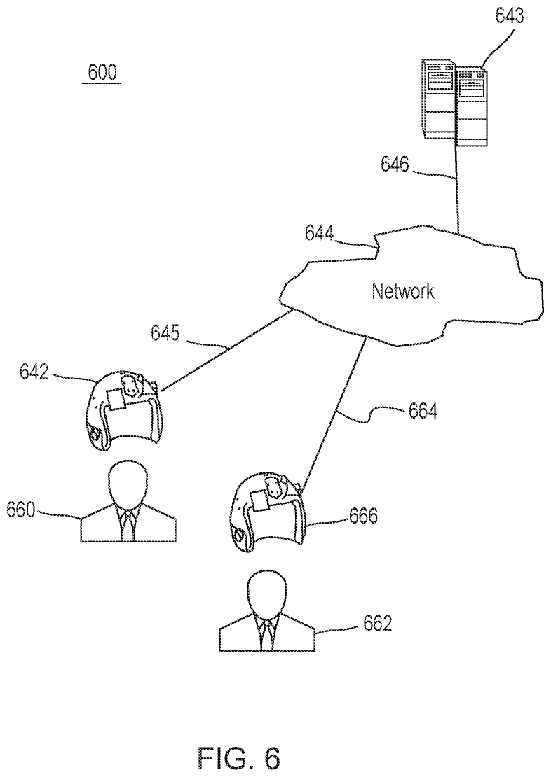

FIG. 6 illustrates a diagram of various example system 600 components that can be used in accordance with aspects of the present disclosure. The system 600 can include one or more accessories 660, 662 (also referred to interchangeably herein as one or more “users,” such as a pilot) and one or more terminals 642, 666 (such terminals can be or include, for example, various features of the motion sensors (e.g., IMUs), displays, INS, and/or related processing within other components in a helmet) within an overall aircraft or other vehicle network. In one aspect, data for use in accordance with aspects of the present disclosure is, for example, input and/or accessed by accessories 660 (which can be communicatively coupled to handheld radios of the present disclosure), 662 via terminals 642, 666, coupled to a server 643, such as the symbols, IMUs, displays, INS, and/or related processing within other components in radio or common battery of FIGS. 1-5, and/or other device having a processor and a repository for data and/or connection to a repository for data, via, for example, a network 644, such as the Internet, an intranet, and/or an aircraft communication system, and couplings 645, 646, 664. The couplings 645, 646, and 664 include, for example, wired, wireless, or fiber optic links. In another example variation, the system in accordance with aspects of the present disclosure operate in a stand-alone environment, such as on a single terminal.

FIG. 7 illustrates isometric views of the tops of the L3 Harris, Thales, and common batteries. To enable comparisons among the common battery 200 of the present disclosure, the AN/PRC-163 battery 301, and the AN/PRC-148D battery 302. FIG. 7 displays an angle of the circular piloting alignment feature 210 on the common battery 200, the raised plastic wall 701 around the contacts on the AN/PRC-163 battery 301, and the absence of a wall on the Thales battery (AN/PRC-148) 302. The raised wall 701 around the contacts of the L3 Harris battery interferes with the AN/PRC-148 radio. The raised plastic wall 210 on the common battery 200 allows for alignment to the AN/PRC-148 and AN/PRC-163 radios and serves to prevent side loading of the L3 Harris radio contact pins, and also reduces the risk of incorrect/incomplete mating thereby forcing users to perform multiple installations of the battery to the radios.

By way of example, an element, or any portion of an element, or any combination of elements can be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system can execute software. Software shall be construed broadly to include instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example variations, the functions described above can be implemented in hardware, software, firmware, or any combination thereof. If implemented in software, the functions can be stored on or encoded as one or more instructions or code on a computer-readable medium or media. Computer-readable media includes computer storage media. Storage media can be any available media that is able to be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk, where disks usually reproduce data magnetically, while discs reproduce data optically with lasers. Combinations of the above should also be included within the scope of computer-readable media.

While the aspects described herein have been described in conjunction with the example aspects outlined above, various alternatives, modifications, variations, improvements, and/or substantial equivalents, whether known or that are or can be presently unforeseen, can become apparent to those having at least ordinary skill in the art. Accordingly, the example aspects, as set forth above, are intended to be illustrative, not limiting. Various changes can be made without departing from the spirit and scope of the disclosure. Therefore, the disclosure is intended to embrace all known or later-developed alternatives, modifications, variations, improvements, and/or substantial equivalents.

It is understood that the specific blocks performing various tasks of the present disclosure can be arranged and rearranged. Further, some blocks can be combined or omitted. Thus, the accompanying elements of the various blocks comprise a sample order, component, module, etc., and are not meant to be limited to the specific blocks.

The previous disclosure is provided to enable any person skilled in the art to practice the various aspects described herein. Various modifications to these aspects will be readily apparent to those skilled in the art, and the generic principles defined herein can be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and can include multiples of A, multiples of B, or multiples of C. Specifically, combinations such as “at least one of A, B, or C,” “at least one of A, B, and C,” and “A, B, C, or any combination thereof” can be A only, B only, C only, A and B, A and C, B and C, or A and B and C, where any such combinations can contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A common battery for providing power to a first radio of a plurality of radios, the plurality of radios including at least a first radio and a second radio, the common battery having a size of a smaller of a size of a first battery of the first radio and a size of a second battery of the second radio, the common battery comprising:
a raised concentric wall edge for enabling the common battery to lock in place when used in place of a larger of the first battery and the second battery within a Vehicular Adaptor Amplifier, the raised concentric wall edge having a height of a difference between a height of the first battery and a height of the second battery; and
a circular piloting interface that uses an outside radius of a respective bayonet connector on the first radio and the second radio to align the respective radio to the common battery.

2. The common battery of claim 1, wherein the first radio comprises AN/PRC-148D radio and the second radio comprises an AN/PRC-163 radio, and wherein the common battery is compatible with the AN/PRC-148D radio and the AN/PRC-163 radio.

3. The common battery of claim 1, wherein a housing of the common battery comprises the raised concentric wall edge configured to lock in place the common battery within vehicular amplifier adaptors for an AN/PRC-163 radio and an AN/PRC-148 radio.

4. The common battery of claim 1, wherein the first radio of the plurality of radios comprises one or more of: a display, a video capture and transmission component, a positioning system, an antenna, a frequency management and/or selection module, a motion sensor, and at least one processor.

5. The common battery of claim 1, wherein the first radio of the plurality of radios comprises: a handheld radio, a radio mountable on a wearable object, or a radio mountable on another object.

6. The common battery of claim 5, wherein the another object comprises a vehicle.

7. A system for providing power to a first radio of a plurality of radios, the plurality of radios including at least a first radio and a second radio, the system including at least:
a common battery having a size of a smaller of a size of a first battery of the first radio and a size of a second battery of the second radio, the common battery comprising:
a raised concentric wall edge for enabling the common battery to lock in place when used in place of a larger of the first battery and the second battery within a Vehicular Adaptor Amplifier, the raised concentric wall edge having a height of a difference between a height of the first battery and a height of the second battery; and
a circular piloting interface that uses an outside radius of a respective bayonet connector on the first radio and the second radio to align the respective radio to the common battery.

8. The system of claim 7, further comprising: a display component.

9. The system of claim 8, wherein the first radio includes the display component.

10. The system of claim 8, wherein the display component is mountable on a wearable object.

11. The system of claim 7, further comprising: a video capture and transmission component.

12. The system of claim 7, further comprising: a positioning system.

13. The system of claim 7, further comprising: an antenna.

14. The system of claim 7, further comprising: a frequency management and/or selection module.

15. The system of claim 7, further comprising: a motion sensor.
